(19) United States
(12) Patent Application Publication
(10) Pub. No.: US 2021/0197985 A1
(43) Pub. Date: Jul. 1, 2021

(54) ASSEMBLY AND METHOD FOR HANDLIING AN AIRCRAFT PROPULSION UNIT

(71) Applicant: Safran Nacelles, Gonfreville L'Orcher (FR)

(72) Inventor: Denis GUILLOIS, MOISSY CRAMAYEL (FR)

(73) Assignee: Safran Nacelles, GONFREVILLE L'ORCHER (FR)

(21) Appl. No.: 17/184,392

(22) Filed: Feb. 24, 2021

Related U.S. Application Data
(63) Continuation of application No. PCT/FR2019/051951, filed on Aug. 22, 2019.

(30) Foreign Application Priority Data
Aug. 24, 2018 (FR) 18/57647

(51) Int. Cl. B64F 5/50; F02C 7/20

(52) U.S. Cl. CPC B64F 5/50; F05D 2230/60; F05D 2220/323; F02C 7/20

(57) ABSTRACT

A handling assembly of a propulsion assembly includes a frame which includes three radially spaced arms and is mobile in rotation about an axis transverse to a longitudinal axis of the handling assembly, and three branches for handling the nacelle, which are mounted transversally on the arms of the frame, extend along the longitudinal axis and include a working branch, which is movable between a rest position allowing a clearance with an inner wall of an air intake of the nacelle and a working position in which the working branch comes into contact with the inner wall, so as to exert a pressing force of the handling branches on the inner wall of the air intake. A method for handling a propulsion assembly using the handling assembly is also included.

### CROSS-REFERENCE TO RELATED APPLICATIONS

This application is a continuation of International Application No. PCT/FR2019/051951, filed on Aug. 22, 2019, which claims priority to and the benefit of FR 18/57647 filed on Aug. 24, 2018. The disclosures of the above applications are incorporated herein by reference.

### FIELD

The present disclosure relates to an assembly for handling an aircraft propulsion unit and to a method for handling such an aircraft propulsion unit.

### BACKGROUND

The statements in this section merely provide background information related to the present disclosure and may not constitute prior art.

An aircraft is moved by several propulsion units each comprising a turbojet engine housed in a nacelle.

As represented in FIG. 1, a propulsion unit 1 comprises a nacelle 3 and a turbojet engine 5, for example of the bypass type, capable of generating, by means of the blades of the rotating fan, a flow of hot gases (also called primary flow) and a cold air flow (also called secondary air flow) which circulates outside the turbojet engine through an annular passage 7, also called annular flow path, formed between two concentric walls of the nacelle. The primary and secondary flows are ejected from the turbojet engine through the rear of the nacelle.

The nacelle 3 generally has a tubular structure comprising an upstream section, or air inlet 9, located upstream of the turbojet engine, a median section 11 intended to surround a fan of the turbojet engine, a downstream section 13 intended to surround the combustion chamber of the turbojet engine, incorporating a thrust reverser device, and may be terminated by an ejection nozzle located downstream of the turbojet.

In order to carry out maintenance operations on the nacelle, it is desirable to be able to manipulate the air inlet of the nacelle, independently of its median and downstream sections.

Reference is made to FIG. 2 illustrating a variation of a propulsion unit which makes it possible to manipulate an air inlet using a conventional handling assembly.

The conventional handling assembly 15 includes two slings 17, connected and fixed at the lower end to an outer wall 19 of the air inlet 9 of the nacelle in contact with the external air flow flowing around the nacelle when the nacelle is in operation.

To do this, the nacelle includes at its outer wall 19 two attachment fittings 21, forming hoisting points on which the slings 17 are mounted.

When the slings 17 are mounted on the attachment fittings 21 of the air inlet 9, an operator can manipulate the air inlet, for example as illustrated in FIG. 3 by tilting it vertically in order to be able to dispose it on the floor in this vertical position.

A recurring challenge for aircraft manufacturers is that of reducing the aerodynamic disturbances of the nacelle. To do this, the nacelle manufacturers seek to make certain surfaces of the nacelle smooth, in particular the outer wall of the nacelle.

This achieve reduced aerodynamic disturbance, a nacelle including a so-called laminar air inlet is provided, that is to say an air inlet free of the attachment fittings on which the slings of the conventional handling assembly are intended to be mounted.

The removal of the attachment fittings from the outer wall of the air inlet of the nacelle makes it difficult to handle the nacelle using conventional handling assemblies.

### SUMMARY

This section provides a general summary of the disclosure and is not a comprehensive disclosure of its full scope or all of its features.

The present disclosure includes a handling assembly for an air inlet of a nacelle, in particular of the type which does not include any attachment point at its outer wall.

The present disclosure also provides a handling assembly for a propulsion unit including a nacelle and an aircraft turbojet engine, the handling assembly including a frame, including at least three radially spaced apart arms, the frame being rotatably movable about an axis transverse to a longitudinal axis of the handling assembly, and at least three manipulation branches of the nacelle, each being mounted transversely on one of the at least three arms of the frame, extending along the longitudinal axis of the handling assembly, the at least three manipulation branches including at least one movable working branch, relative to the arm on which the working branch is mounted, when activating a actuating means for actuating the working branch, between a rest position authorizing a clearance with an inner wall of an air inlet of the nacelle when the propulsion unit is mounted on the handling assembly, and a working position according to which the working branch comes into contact with the inner wall of the air inlet of the nacelle, so as to exert a plating force of the manipulation branches on the inner wall of the air inlet.

Thus, by providing a handling assembly including manipulation branches exerting a pressing force on the inner wall of the air inlet, the handling assembly can be used on nacelles whose air inlet is laminar, that is to say which does not include an attachment fitting.

According to optional characteristics of the handling assembly: the actuating means for actuating the working branch includes a preload spring, including a first end mounted on the working branch and a second end mounted on the arm on which the working branch is mounted; at least one of the manipulation branches is at least partly sheathed in an elastomeric material; this allows to not damage the inner wall of the air inlet. The presence of the elastomeric coating around the manipulation branches also makes it possible to transmit a good plating force of the manipulation branches on the inner wall of the air inlet.

In one form of the present disclosure, the handling assembly further includes a support arm intended to be connected to an outer hoisting ring, the frame being mounted in rotation on the support arm about the axis transverse to the longitudinal axis of the handling assembly.

In another form, the support arm is at least partly sheathed in an elastomeric material.

In still another form, the handling assembly includes a counterweight mounted at one end of the frame of the handling assembly, so as to allow horizontal held of the propulsion unit when a propulsion unit is mounted on the handling assembly.

In yet another form, the handling assembly further includes a blocking device for blocking the air inlet of the nacelle in translation when the propulsion unit is mounted on the handling assembly.

In another form, at least one of the at least three manipulation branches includes a sheath and an opening, and the blocking device for blocking in translation the air inlet includes: at least one blocking latch, mounted on at least one manipulation branch of the handling assembly, and an actuating means of actuating the blocking latch, the at least one blocking latch being movable along a vertical axis of the manipulation branch when activating the actuating means of the blocking latch, between a rest position according to which the blocking latch is contained inside the sheath of the manipulation branch and a blocking position according to which the blocking latch is at least partially extracted from the sheath through the opening of the manipulation branch, so as to define a stop in contact with a downstream edge of the air inlet of the nacelle when the propulsion unit is mounted on the handling assembly.

In some configurations, the actuating means for actuating the blocking latch may include a blocking latch actuator device. The blocking latch actuator device includes a blocking control slide, a follower slide, movably mounted inside the sheath, a cam, engaged with the follower slide and with the blocking latch, a tie rod, including a first end secured to the follower slide and a second end secured to the blocking control slide, the blocking control slide being movably mounted along the frame of the handling assembly, between a rest position corresponding to the rest position of the blocking latch and a blocking position corresponding to the blocking position of the blocking latch.

In some configurations, when the blocking control slide is in its rest position, a longitudinal clearance J is defined between the blocking control slide and the arms of the frame of the handling assembly, and when the clearance J is consumed, the blocking control slide moves from its rest position to its blocking position.

The present disclosure also includes a method for handling a propulsion unit, the propulsion unit comprising: a nacelle comprising an air inlet, and an aircraft turbojet engine, including a fan casing on which the air inlet of the nacelle is attached, the handling method including the following successive steps aiming at: introducing the manipulation branches of the handling assembly according to the present disclosure, inside the air inlet of the nacelle; moving the working branch from its rest position authorizing a clearance with an inner wall of the air inlet of the nacelle to its working position according to which the working branch comes into contact with the inner wall of the air inlet from the nacelle, so as to exert a force of plating the manipulation branches on the inner wall of the air inlet; detaching the air inlet from the fan casing of the turbojet engine.

The handling method of the present disclosure can further include an additional step, subsequent to the step according to which the working branch move from its rest position to its working position and prior to which the air inlet is detached from the fan casing of the turbojet engine, aiming at displacing the blocking latch from its rest position according to which the blocking latch is contained inside the sheath of the manipulation branch towards its blocking position according to which the blocking latch is at least partially extracted from the sheath through the opening of the manipulation branch, so as to define a stop in contact with a downstream edge of the air inlet of the nacelle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a longitudinal sectional view of a propulsion unit of the prior art;

FIG. 2 is a perspective view of a handling assembly of the prior art supporting an air inlet of a turbojet engine nacelle;

FIG. 3 is a side view of the handling assembly of FIG. 2;

FIG. 4 is a front view of the handling assembly according to the present disclosure;

FIG. 5 is a sectional view along the line V-V of FIG. 4, the handling assembly supporting an air inlet of the turbojet engine nacelle in a horizontal position;

FIG. 6 is a detailed view of the zone VI of FIG. 5;

FIG. 7 is a view similar to that of FIG. 6, the blocking device of the handling assembly being in the blocking position;

FIG. 8 is a sectional view along the line VIII-VIII of FIG. 6; and

FIG. 9 is a view similar to that of FIG. 5, the handling assembly supporting an air inlet of the turbojet engine nacelle in a vertical position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

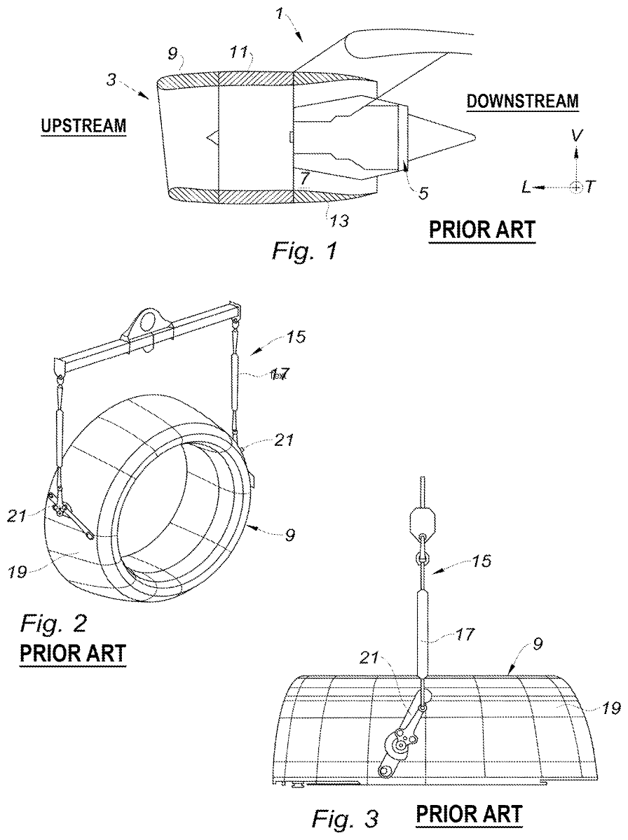

In the description and in the claims, the terms «upstream» and «downstream» should be understood in relation to the circulation of the air flow inside the propulsion unit formed by the nacelle and the turbojet engine, that is to say from left to right with reference to FIG. 1.

Likewise, the expressions «inner» or «internal» and «outer» or «external» will be used without limitation with reference to the radial distance relative to the longitudinal axis of the propulsion unit, the expression «inner» or «internal» defining an area radially closer to the longitudinal axis of the nacelle, as opposed to the expression «outer» or «external».

Moreover, in the description and the claims, to clarify the description and the claims, the longitudinal, vertical and transverse terminology will be adopted without limitation with reference to the direct trihedron L, V, T indicated in the figures, whose longitudinal axis L is parallel to the longitudinal axis of the handling assembly.

Furthermore, in all of the figures, identical or similar references represent identical or similar organs or sets of organs.

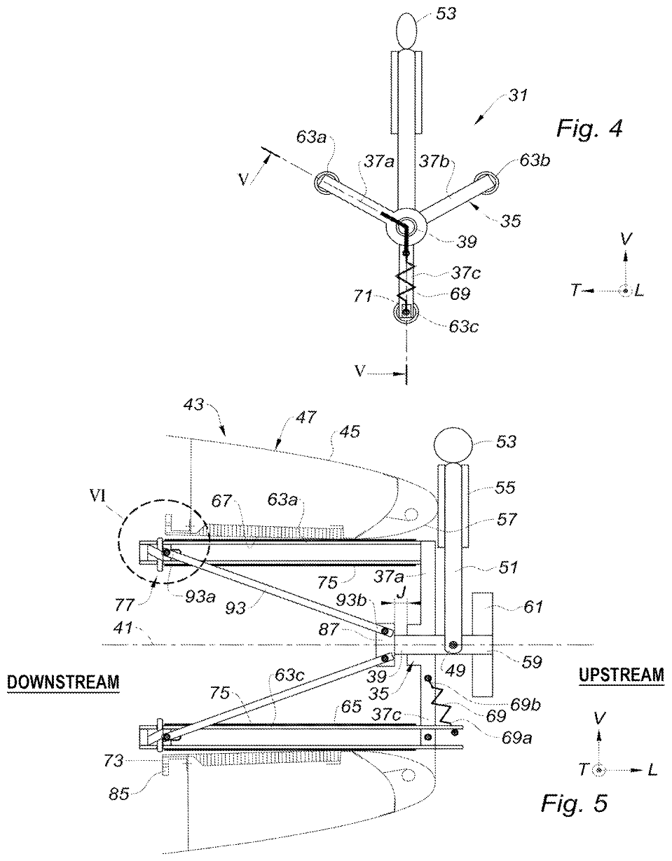

Reference is made to FIG. 4 illustrating the handling assembly or unit 31 of the present disclosure in front view, and to FIG. 5 illustrating in section along the line V-V of FIG. 4 the handling assembly 31 supporting an air inlet from a turbojet engine nacelle.

The handling assembly or unit 31 includes a frame 35. The frame 35 includes in the given example three arms 37a, 37b, 37c, which are radially spaced from one another and which are mounted on a hub 39. In one form, the angle formed by two consecutive arms is approximately equal to 120°. It can be envisaged to provide an angle between two different consecutive arms so that the arms 37a, 37b, 37c are not regularly distributed radially. Also, in one form, it can be envisaged to mount more arms to form the frame, for example four arms.

The frame 35 includes a longitudinal axis 41 which corresponds to the longitudinal axis of the hub 39, which still corresponds to the longitudinal axis of a propulsion unit 43 when such a propulsion unit is mounted on the handling unit 31. It will be noted that in all of the figures, only an air inlet 45 of a nacelle 47 of the propulsion unit 43 is represented in the maintenance position on the handling unit 31.

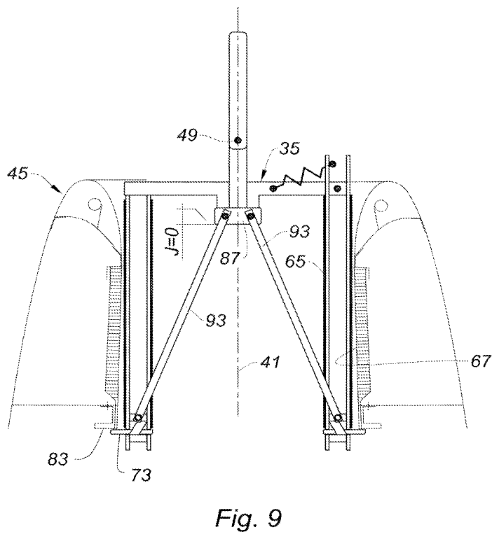

The frame 35 is rotatably movable about an axis 49 transverse to the longitudinal axis 41 of the handling assembly, so as to allow a passage of the air inlet 45 of the nacelle from its horizontal position represented in FIG. 5 towards a vertical position (visible in FIG. 9) as will be seen in the remainder of the description. By way of example, the rotation of the frame 35 can be obtained by means of a support arm 51 intended to be connected to a hoisting ring 53 external to the handling assembly or to any other lifting system, and by mounting the hub 39 of the frame 35 in rotation on the support arm 51, about the axis 49 transverse to the longitudinal axis 41 of the handling assembly 31.

In one form, the support arm 51 may be at least partly sheathed with an elastomeric material 55, in order not to damage the leading edge 57 of the air inlet 45 when the propulsion unit 43 is mounted on the handling unit 31.

In order to allow the propulsion unit 43 to be maintained in a horizontal position on the handling assembly 31, the upstream end 59 of the frame, that is to say the end which is closest to the leading edge of the air inlet 45 when the propulsion unit 43 is mounted on the handling unit, is provided with a counterweight 61 which can be mounted on the hub 39.

The handling assembly 31 of the present disclosure further includes, in the given example of a frame with three arms, three manipulation branches 63a, 63b, 63c of the air inlet 45 of the nacelle 47. Each branch 63a, 63b, 63c is respectively mounted on each of the arms 37a, 37b, 37c of the frame 35, transversely to the latter. In other words, the manipulation branches 63a, 63b, 63c of the air inlet extend along the longitudinal axis 41 of the handling assembly 31.

According to the present disclosure, at least one of the manipulation branches is a so-called working branch. In the example, the manipulation branch 63c forms a working branch 65.

The working branch 65 is used in order to allow a good plating of all the branches on an inner wall 67 of the air inlet 45. For this purpose, the working branch 65 is movable relative to the arm 37c of the frame on which it is mounted, when activating an actuating means.

According to the example, such an actuating means can be achieved by planning to mount an elastic means such as a preload spring 69 between the working branch 65 and the arm 37c of the frame.

According to a non-illustrated variant, the means for actuating the working branch can be an actuator such as a hydraulic, pneumatic or electric cylinder.

The preload spring 69 includes a first end 69a mounted on the working branch 65 and a second end 69b mounted on the arm 37c on which the working branch 65 is mounted. The end of the arm 37c radially furthest from the hub 39 can be provided with a groove 71 along which the working branch 65 can be displaced when the preload spring 69 is biased.

In a rest or initial position of the working branch 65, a clearance (not visible in the figures) is defined between the working branch 65 and the inner wall 67 of the air inlet 45 of the nacelle.

In a working position of the working branch 65, such as that represented in FIG. 5, the preload spring 69 is compressed and the working branch 65 comes into contact with the inner wall 67 of the air inlet and is held plated against this inner wall under the action of the spring.

The plating force obtained by the working branch 65 is transmitted to the manipulation branches 63a, 63b, so that all the manipulation branches of the handling assembly exert a plating force on the inner wall 67 of the air inlet 45.

When the manipulation branches 63a, 63b, 63c come into contact with the inner wall 67 of the air inlet 45 and exert a plating force on this inner wall, the air inlet 45 can be safely detached from the fan casing (not visible in FIG. 5) to which the air inlet is attached when the nacelle is in operation. To do this, the fan casing is detached from the turbojet engine at the level of the fixing flange 73 of the air inlet 45.

According to a variant, the manipulation branches 63a, 63b, 63c are sheathed, over a portion of their length or over all of their length, with an elastomeric material 75. This makes it possible not to damage the inner wall 67 of the air inlet. The presence of the elastomeric coating around the manipulation branches further increases the plating force of the manipulation branches on the inner wall 67 of the air inlet. In one form, only one or two of the manipulation branches 63a, 63b, 63c is sheathed with the elastomeric material 75.

In one form of the handling assembly 31, the handling assembly includes a blocking device 77 in translation of the air inlet 45 of the nacelle when the propulsion unit 43 is mounted on the handling assembly, designed and arranged in the handling assembly to block the air inlet in translation along the longitudinal axis 41 of the handling assembly 31.

As we have seen previously, the plating force of the manipulation branches 63a, 63b, 63c on the inner wall 67 of the air inlet 45 makes it possible to safely detach the air inlet 45 from the fan casing.

The blocking device 77 makes it possible, by blocking the translation of the air inlet along the longitudinal axis of the handling assembly, to further secure the maintenance of the air inlet by the manipulation branches 63a, 63b, 63c.

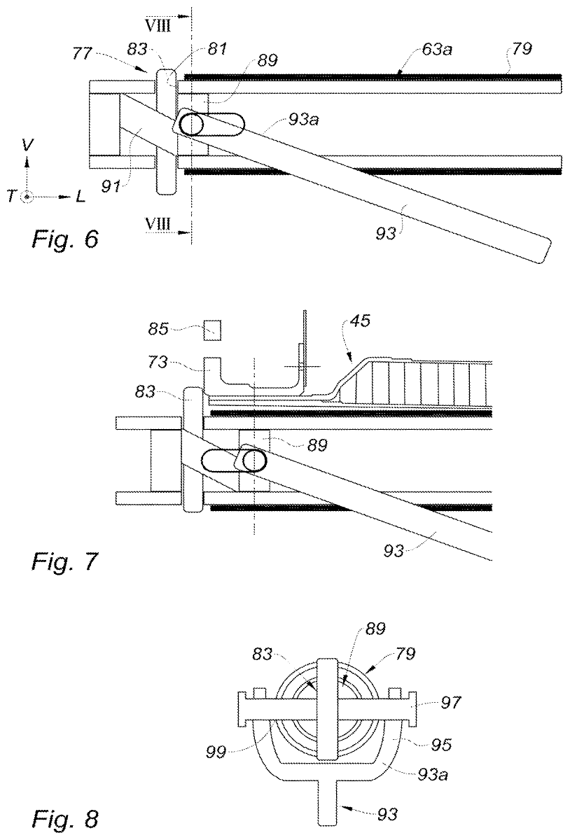

In one form of this device for blocking the air inlet is given by way of example with reference to FIGS. 5 to 8 to which reference is made, FIG. 6 being an enlargement of zone VI of FIG. 5, FIG. 7 being a view similar to that of FIG. 6, the handling assembly being in the blocking position, and FIG. 8 being a sectional view along the lines VIII-VIII of FIG. 6.

It is envisioned according to the represented variation to provide as many blocking devices as the handling assembly includes arms and manipulation branches. It can obviously also be envisaged to provide the handling assembly with a single blocking device, or with two blocking devices when the handling assembly includes three arms and three manipulation branches. The blocking device 77 is described in the remainder of the description with reference to the manipulation branch 63a and is duplicated identically for the other manipulation branches of the handling assembly.

The blocking device 77 is obtained first of all by planning to make the manipulation branch 63a in the form of a sheath 79 including an opening 81 made along a vertical axis of the sheath. Next, the blocking device 77 includes a blocking latch 83 mounted on the manipulation branch 63a. The blocking latch 83 can be activated by a blocking latch actuator device, a variation of which will be given by way of example in the following description.

The blocking latch 83 is movable along a vertical axis of the manipulation branch when the blocking latch actuator device is activated between a rest position in which the blocking latch 83 is contained inside the sheath 79 and a blocking position represented in FIG. 7.

In this blocking position, the blocking latch 83 is at least partially extracted from the sheath 79 through the opening 81. The blocking latch 83 defines in this blocking position a stop, whose downstream edge 85 of the air inlet 45, for example the connecting flange 73 to the fan casing, comes into contact when the propulsion unit is mounted on the handling assembly and the fan casing has been detached from the air inlet as previously seen.

According to an exemplary variation of the blocking latch actuator device, the blocking latch actuator device includes a blocking control slide 87 (visible in FIG. 5) defining, for a rest position corresponding to a rest position of the blocking latch a longitudinal a clearance J defined between the blocking control slide 87 and the arms 37a, 37b, 37c of the frame 35 of the handling assembly.

The blocking latch actuator device further includes a follower slide 89 movably mounted inside the sheath 79, as well as a cam 91 mounted in engagement with the follower slide 89 and with the blocking latch 83.

The movement of displacement of the blocking control slide 87 is transmitted to the assembly formed by the follower slide 89, the cam 91 and the blocking latch 83 thanks to a tie rod 93. The tie rod 93 includes for this purpose a first end 93a secured to the follower slide 89 and a second end secured to the blocking control slide 87.

By consuming the clearance J, the blocking control slide 87 moves from its rest position to its blocking position corresponding to the blocking position of the blocking latch. The consumption of the clearance J can be obtained manually by the action of an operator directly on the blocking control slide 87.

FIG. 8, which is a sectional view along the line VIII-VIII of FIG. 6, has been given a representation of the connection between the end 93a of the tie rod and the assembly formed by the sheath 79, the follower slide 89, the blocking latch 83 and the cam 91. The end 93a of the tie rod 93 includes a fork 95 on which is fixed a rod 97 passing through a transverse opening 99 of the sheath 79 and passing through the follower slide 89.

As we have seen previously, the plating force of the manipulation branches 63a, 63b, 63c on the inner wall 67 of the air inlet 45 makes it possible to safely detach the air inlet 45 from the fan casing. This plating force is also sufficient to effect a tilting of the air inlet in a vertical position. Nonetheless, the fact of equipping the handling assembly 31 with a device for blocking the air inlet in translation makes it possible to further secure the maintenance of the air inlet in position when moving the air inlet from its horizontal position to its vertical position represented in FIG. 9 to which reference is now made.

When the clearance J has been consumed, the blocking control slide 87 is returned to its blocking position and together caused the blocking latch 83 to move into its blocking position in which it forms a stop on which the downstream edge 85 of the air inlet comes into contact. Maintaining the blocking control slide 87 in the blocking position can be provided by any mechanical connecting means known to one skilled in the art.

The rotating of the frame 35 on its axis of rotation 49 transverse to the longitudinal axis 41 of the handling assembly causes the passage of the air inlet 45 from its horizontal position represented in FIG. 5 towards its vertical position.

When the air inlet 45 is in a vertical position, the air inlet is disposed in its vertical position on a suitable support, for example on the floor. The working branch 65 of the handling assembly can move from its working position towards its rest position authorizing a clearance with the inner wall 67 of the air inlet, thus freeing the inner wall 67 of the air inlet from the plating force to which it was subjected, allowing the removal of the manipulation branches from the interior of the air inlet.

As goes without saying, the present disclosure is not limited to the only forms of this handling assembly and of this handling method, described above only by way of illustrative examples, but on the contrary it encompasses all the variants involving the technical equivalents of the means described as well as their combinations if these fall within the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A handling assembly of a propulsion unit including a nacelle and an aircraft turbojet engine, the handling assembly including:
a frame, the frame including at least three arms radially spaced from one another, the frame being rotatably movable about a transverse axis transverse to a longitudinal axis of the handling assembly; and
at least three manipulation branches of the nacelle, each of the at least three manipulation branches being mounted transversely on one of the at least three arms of the frame and extending along the longitudinal axis of the handling assembly, the at least three manipulation branches including at least one movable working branch, the at least one movable working branch being movable relative to an arm of the at least three arms on which the at least one movable working branch is mounted when an actuator for actuating the at least one moveable working branch is activated between an initial position wherein there is a clearance between the at least one moveable working branch and an inner wall of an air inlet of the nacelle when the propulsion unit is mounted on the handling assembly, and a working position wherein the at least one moveable working branch comes into contact with the inner wall of the air inlet of the nacelle, such that the at least three manipulation branches apply a plating force on the inner wall of the air inlet.

2. The handling assembly according to claim 1, wherein the actuator for actuating the at least one moveable working branch includes a preload spring having a first end mounted on the at least one moveable working branch and a second end mounted on the arm on which the at least one moveable working branch is mounted.

3. The handling assembly according to claim 1, wherein at least one of the at least three manipulation branches is at least partly sheathed with an elastomeric material.

4. The handling assembly according to claim 1, further comprising a support arm intended to be connected to an outer hoisting ring, the frame being rotatably mounted on the support arm about the transverse axis transverse to the longitudinal axis of the handling assembly.

5. The handling assembly according to claim 4, wherein the support arm is at least partly sheathed in an elastomeric material.

6. The handling assembly according to claim 1, further comprising a counterweight mounted at one end of the frame of the handling assembly, such that the propulsion unit is held horizontally when the propulsion unit is mounted on the handling assembly.

7. The handling assembly according to claim 1, further comprising a blocking device for blocking the air inlet of the nacelle in translation when the propulsion unit is mounted on the handling assembly.

8. The handling assembly according to claim 7, wherein at least one manipulation branch of the at least three manipulation branches comprises a sheath and an opening, the blocking device for blocking the air inlet in translation including:
at least one blocking latch mounted on the at least one manipulation branch of the at least three manipulation branches of the handling assembly; and
a blocking latch actuator device for actuating the at least one blocking latch, the at least one blocking latch being movable along a vertical axis of the at least one manipulation branch when the blocking latch actuator device is activated between a first rest position wherein the at least one blocking latch is contained inside the sheath of the at least one manipulation branch and a first blocking position wherein the at least one blocking latch is at least partly extracted from the sheath through the opening of the at least one manipulation branch such that a stop in contact with a downstream edge of the air inlet of the nacelle is defined when the propulsion unit is mounted on the handling assembly.

9. The handling assembly according to claim 8, wherein the blocking latch actuator device for actuating the at least one blocking latch includes:
a blocking control slide;
a follower slide, movably mounted inside the sheath;
a cam, engaged with the follower slide and with the at least one blocking latch; and
a tie rod, including a first end secured to the follower slide and a second end secured to the blocking control slide,
the blocking control slide being movably mounted along the frame of the handling assembly, between a second rest position corresponding to the first rest position of the at least one blocking latch and a second blocking position corresponding to the first blocking position of the at least one blocking latch.

10. The handling assembly according to claim 9, wherein, when the blocking control slide is in the second rest position, a longitudinal clearance is defined between the blocking control slide and the at least three arms of the frame of the handling assembly, and when the clearance is consumed, the blocking control slide moves from the second rest position towards the second blocking position.

11. A method for handling a propulsion unit comprising a nacelle and an aircraft turbojet engine, the nacelle including an air inlet and the aircraft turbojet engine including a fan casing on which the air inlet of the nacelle is attached, the method comprising:
(a) introducing the at least three manipulation branches of the handling assembly of claim 1 inside the air inlet of the nacelle;
(b) moving the at least one movable working branch of the handling assembly of claim 1 from the initial position wherein there is the clearance between the at least one moveable working branch and the inner wall of the air inlet of the nacelle towards the working position wherein the at least one moveable working branch comes into contact with the inner wall of the air inlet of the nacelle, such that the at least three manipulation branches apply the plating force on the inner wall of the air inlet; and
(c) detaching the air inlet from the fan casing of the aircraft turbojet engine.

12. The method according to claim 11, wherein the handling assembly is of claim 8, the method further including:
(d) displacing the at least one blocking latch from the first rest position wherein the at least one blocking latch is contained inside the sheath of the at least one manipulation branch towards the first blocking position wherein the at least one blocking latch is at least partially extracted from the sheath through the opening of the at least one manipulation branch such that the stop in contact with the downstream edge from the air inlet of the nacelle is defined, displacing the at least one blocking latch from the first rest position towards the first blocking position prior to the air inlet of the fan casing of the aircraft turbojet engine is detached and after the at least one moveable working branch is moved from the rest position towards the working position.
